(19) United States
(12) Patent Application Publication
(10) Pub. No.: US 2008/0075020 A1
(43) Pub. Date: Mar. 27, 2008

(54) Data Communications Network with a Decentralized Communications Management

(75) Inventors: Stephan Hemberger, Bad Boll (DE); Ingo Kreuz, Aidlingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/587,823

(22) PCT Filed: Apr. 12, 2005
(86) PCT No.: PCT/EP05/03811

§ 371 Date: Oct. 31, 2007

(30) Foreign Application Priority Data
Apr. 30, 2004 (DE) 10 2004 021 385.2

(51) Int. Cl. H04L 12/28

(52) U.S. Cl. 370/255

(57) ABSTRACT

The invention relates to a data communications network with a plurality of network nodes, which in each case have one or more communications ports and an identifying node ID and are designed for decentrally managing connections and for transmitting data packets of a non-directional type and of a directional type, whereby the data packets contain header information at least concerning the packet type and node ID of the packet-generating network node. According to the invention, a special adjacent monitoring facility, a special broadcast functionality and/or a special connection set-up functionality are implemented in each fully implemented network node of the network in such a way that a self-organizing communications management is produced purely by means of decentralized, local measures, so that the network can be implemented as a distributed system which requires no central instances and thereby fulfills requirements concerning robustness, topology flexibility, expandability and scalability, identical component reusability, universality and real-time ability. The invention can be used, for example, for data communications networks in motor vehicles.

### BACKGROUND OF THE INVENTION

The invention relates to a data communications network with a plurality of network nodes, which in each case has one or more communications ports and an identifying node ID and is designed for decentrally managing interconnections and transmitting data packets of a non-directional type and of a directional type, whereby the data packets contain header information at least concerning the node ID of the packet-generating network node.

Data communications networks of this type, which form “distributed systems”, are known in various forms. The term “data communications network” is used here, as is conventional in the technical field of electronic data processing, to refer to a network, i.e., in the language of graph theory, a graph comprising any given network nodes and network edges, wherein the network nodes are formed from physical units with data communications and data processing capability, for this reason normally also referred to as cells or computing units, and the network edges are formed from wired or wireless data transmission paths. Complex embedded data communications systems are frequently implemented as networks of this type. One example involves networks of the type used in modern motor vehicles, in which a multiplicity of control devices and other units operate with data communications and data processing capability as network nodes which are networked via data bus lines.

Data packets of different types, including a non-directional type and a directional type, are transmitted via the connections between network nodes. Data packets of the non-directional type, also referred to as “broadcast type”, are those that are output by the relevant network node on all its activated ports, with the exception of the port on which the data packet is received, if this does not involve the data-packet-generating network node. Data packets of the directional type, also referred to as “connection-oriented”, are those that are transmitted specifically to a predefinable destination network node.

Compared with networks with central communications management, the decentralized networks considered here offer the advantage that they require no central units, such as central router units or name server units. This generally increases the robustness of the system, since a fault in a central unit frequently results in failure of the entire network. Robustness, i.e., resistance to faults, is an important criterion, particularly for safety-critical systems, such as vehicles. In order to fulfill the robustness requirement for the system, the communications between the network nodes should also be designed to be robust. To do this, it is desirable to be able to design the communications paths with any given redundancy as required, to identify faults reliably and report them to the rest of the network, and to localize the effects of faults, so that a fault in one communications path or communications segment does not adversely affect the entire network communications.

Furthermore, in order to achieve maximum design freedom and therefore maximum flexibility for adaptation to a respective given task, it is desirable for the communications management to support any given network topologies, such as the known bus, star, ring, or tree topologies, or mixed forms thereof. The communications management should moreover fulfill the requirement for expandability and scalability in optimum fashion, i.e., it should be possible to implement network variants, that differ only in terms of their performance, with minimal outlay by using more or fewer resources of the same type, or it should be possible for the network to be specialized for a specific field of application through expansion with specific components.

In order to save on development and production costs, it is advantageous, if possible, for only identical components to be used in the network, which, for the communications, means the use of only one scalable connection type if possible. Furthermore, the requirement for universality of the communications management, so that, for example, it can be ensured that the communications can be used independently of the medium employed, and standards can be implemented at the physical level.

In many cases, the requirement also exists for real-time ability. This applies, for example, to embedded systems with control functionalities, as is the case with the aforementioned networks in motor vehicles, which represent an important example of the use of the invention. For the communications, this means the desire to maintain a “Quality of Service” (QoS), i.e., to be able to specify a certain bandwidth and maximum transmission delay in the connection set-up, which are thereafter maintained by the network.

The requirements in terms of the absence of central units, expandability, scalability, and use of identical components can be satisfied from the point of view of the hardware topology by using network nodes that are identical at least in terms of their communications capabilities, such as protocols, routing, and interfaces. To fulfill the requirement that faults have only local effects, it is appropriate for only a small number of communications parties to be connected at each communications interface, ideally only one party, which means point-to-point connections. Routing functionalities are implemented in each network node for communications between indirectly connected network nodes. If it is to be possible to implement any given redundancies and network topologies, each fully implemented network node must be able to communicate directly with at least three parties, i.e., must have at least three ports. With one communications interface, only bus connections are possible at the hardware level and, with two interfaces, ring topologies are also possible, whereas only three interfaces will enable branches and therefore any given network topologies.

WO 02/084956 A1 discloses a routing method for a mobile ad hoc network (MANET). An ad hoc network is a collection of wirelessly linked mobile nodes which dynamically initiate an interconnection. MANETs are used in a WLAN (Wireless Local Area Network) in order to interconnect the computers in a wireless manner. Networks of this type cover several square kilometers and can form a WLAN, HyperLAN or an IEEE 802.11 network. The use of wireless networks of this type in embedded systems in the motor vehicle, for example, in data bus systems with control devices, is not disclosed.

### SUMMARY OF THE INVENTION

The underlying technical problem of the invention is the provision of a data communications network of the aforementioned type, which, depending on the system design, is capable of fulfilling all or, in any event, a large number of the aforementioned system requirements with relatively little outlay.

The invention solves this problem through the provision of a data communications network with the features described herein. Advantageous further developments of the invention are also described.

In one embodiment, a data communications network with actuators, sensors, other electronic components and control devices which are networked with one another via data bus lines is disclosed. In this network, a control device to control the actuators and/or sensors is formed from a plurality of network nodes, which in each case have one or more communications ports and an identifying node ID and are designed to manage connections decentrally and transmit data packets of a non-directional type and/or a directional type. The data packets contain at least header information concerning at least the packet type and the node ID of the packet-generating network node, wherein a monitoring of the functionality of an adjacent network node is implemented in each network node with the following characteristics: on each port which is to be monitored, the network node periodically transmits a ping data packet with header information which is not to be forwarded; the network node activates the port(s) on which it has received a ping data packet from an adjacent node there within a predefinable registration time, and maintains an associated list of directly connected adjacent nodes; if the network node recognizes a new adjacent node on a port on the basis of an associated received ping data packet, it updates its adjacent node list accordingly and transmits an associated Cell Found data packet of the non-directional type; and if the adjacent node receives no further ping data packet and no other data packets on a hitherto activated port within the registration time, it evaluates this as a loss of the previous adjacent node there, updates its adjacent node list accordingly and transmits an associated Cell Lost data packet of the non-directional type.

In a further embodiment, the network may have the feature that a predefinable number of cycles of the periodically transmitted ping data packets are selected as the registration time.

In a further embodiment, the network may have the feature that a respective network node transmits a reregister data packet of the non-directional type in response to the reception of a Cell Found data packet or Cell Lost data packet.

In another embodiment, a data communications network with a plurality of network nodes is disclosed. Each of these nodes has one or more communications ports and an identifying node ID, and is designed to manage connections decentrally and transmit data packets of a non-directional type and/or a directional type, whereby the data packets contain header information concerning at least the packet type and node ID of the packet-generating network node. The data packets of the non-directional type are provided with an identifying packet ID. A broadcast functionality is implemented in a plurality of network nodes with the following characteristics: the network node maintains a list of the packet IDs of already received data packets of the non-directional type and, with reference to the list, checks whether an instantaneously received data packet of the non-directional type has already been received earlier if the network node establishes here that the instantaneously received data packet of the non-directional type has already been received earlier, it rejects it, otherwise it forwards it to all directly connected adjacent nodes.

The network may also have the feature that a packet ID is formed by linking a node ID characterizing a network node with a unique ID generated locally in the network node.

In another embodiment, a data communications network with a plurality of network nodes is disclosed. Each of these nodes has one or more communications ports and an identifying node ID, and is designed to manage connections decentrally and transmit data packets of a non-directional type and/or a directional type, whereby the data packets contain header information concerning at least the packet type and node ID of the packet-generating network node. A connection set-up functionality has the following characteristics for setting up connection paths for the transmission of data packets of the directional type in a plurality of network nodes: an initiating source network node transmits a Connection Request Packet (CRP) that is transmitted as a data packet of the non-directional type and that contains information concerning a destination network node. Each network node stores the port ID of a port on which it first received the Connection Request Packet as the first routing port of routing information. After receiving the Connection Request Packet, the destination network node transmits a Connection Acknowledgement Packet (CAP) only on the port on which it first received the Connection Request Packet. Each intermediate network node which receives the Connection Acknowledgement Packet forwards it on its stored first routing port and stores the port ID of the receiving port as the second routing port in the routing information, and the source network node recognizes from the reception of the Connection Acknowledgement Packet that the connection is set up and communicates with the destination network node through data packets of the directional type via the port which receives the Connection Acknowledgement Packet.

In another embodiment, the data communications network, a special adjacent monitoring functionality is implemented in each fully implemented network node. The term “fully implemented” refers here to the network nodes in which the relevant functionality is implemented to its full extent. These are typically all network nodes of the network or at least most of them, whereby, depending on the application concerned, possibly some, in particular peripheral, network nodes are not fully implemented, i.e., do not have the functionality concerned or do not have it to its full extent.

The adjacent monitoring functionality according to the invention includes the periodic despatching of a special adjacent monitoring data packet, referred to here as a ping data packet. This is transmitted periodically by the relevant network node on all its ports and has in its header part, i.e., as header information, the information concerning the node ID of the network node and preferably also the information indicating that a corresponding ping packet type is involved. In addition, the ping data packet does not need to contain any useful data information, i.e., a particularly simple data packet type is then involved.

A network node that receives a ping data packet on one of its ports activates this port, whereby the ping data packet is not forwarded. The term “activate” is used here to mean that the network node makes the corresponding port ready for the transmission of data packets of the non-directional or directional type, i.e., the network node can transmit corresponding data packets to and receive them from the recognized adjacent node via this port.

The network node keeps an associated list of recognized adjacent nodes that are directly connected to it in each case via one of its ports. If it receives no further ping data packet or other data packet on a port with a previously active connection of this type within a predefined signalling time, it recognizes the loss of the previously present adjacent node therefrom. It updates its adjacent node list accordingly and transmits an associated Cell Lost data packet of the non-directional type with the node ID of the lost adjacent node. If a network node recognizes the existence of a new adjacent node using the node ID contained in the received ping data packet, it updates its adjacent node list accordingly and transmits an associated Cell Found data packet of the non-directional type. This recognition of a new adjacent node comprises cases where no adjacent node or a different adjacent node was previously present on the port concerned.

It becomes evident that a flexible, decentralized, self-organizing communications management of the network is enabled with this adjacent monitoring functionality with relatively little outlay, which monitors the network topology autonomously and decentrally, i.e., solely through local measures between adjacent network nodes, and recognizes and signals topology changes.

Since the ping packet can be kept short and does not need to be forwarded, this adjacent monitoring causes only a very small transmission load for the network. The ping data packet is the only message type which has to be transmitted periodically, i.e., cyclically. All other information can be transmitted in an event-controlled manner without causing reliability problems. This results in a very low average network load. Whereas, in conventional security-critical networks, sensitive activation signals, inter alia, are also transmitted typically in a cyclical manner in order to revert automatically to the deactivation condition in the event of communications faults, a one-off “On” or “Off” message is sufficient in the network according to the invention, since faults on a communications path in the network are signalled by the “Cell Lost” packet, to which a suitable response can be initiated.

In a further development of the invention, the signalling time is fixed at a predefinable number of ping transmission cycles, e.g., two ping transmission cycles. If two or the predefined number of ping data packets are therefore missing and no other data packets are received during this time, this is interpreted as a loss of a previous network node on the port concerned.

In a network further developed, a reregister functionality is implemented including the transmission of a corresponding reregister data packet of the non-directional type by a network node, if the latter receives a Cell Found or Cell Lost data packet. This reregister functionality enables the network, in the event of locally recognized topology changes, to update the topology information required in the individual network nodes in a suitable manner, so that, in particular, the special case of a connection of network islands through one or more additional network nodes can also be managed in a self-organizing manner without central instances.

In a further development of the data communications network, a special broadcast functionality, which is designed in such a way that the communications load on the network can be minimized, is implemented in each fully implemented network node without adversely affecting transmission reliability. The essence of the measure is that, on receiving a broadcast data packet, the relevant network node checks whether it has previously received the same packet, and forwards it only if this is not the case; otherwise it rejects it. To do this, each broadcast data packet has an identifying broadcast packet ID, and the network nodes in each case keep a list of the IDs of broadcast data packets already received, e.g., using a ring buffer of sufficient capacity, i.e., the length of the ring buffer is designed in such a way that, with maximum broadcast data traffic, it is possible to store the IDs of all broadcast data packets which occur during the maximum time period during which a broadcast data packet can be in transit, i.e., in the longest cycle of the network. With this broadcast functionality, the unnecessary, redundant forwarding of broadcast data packets is largely avoided.

In a further development of the invention, a basic bandwidth is reserved for the broadcast data packets on each of the network nodes. This still does not mean a specification of a specific QoS. All broadcast data packets therefore arrive reliably, but no specific arrival time is guaranteed.

In a further development of the data communications network, a special connection set-up functionality is implemented in each fully implemented network node, which, again without the involvement of central instances, enables optimum connection paths to be set up for the transmission of data packets of the directional type. To do this, an initiating source network node initially transmits a Connection Request Packet (CRP) as a non-directional broadcast message with data information with which the destination network node identifies itself as such. Each network node that receives the CRP, when it receives this CRP for the first time, marks the relevant port as a first routing port by means of an entry in a stored list with routing information. On receiving the CRP, the destination network node transmits a Connection Acknowledgement Packet (CAP) only on the port on which it first received this CRP. Each intermediate network node that receives the confirmation packet forwards it on its marked first routing port and marks the receiving port as its second routing port.

The source network node recognizes from the reception of the Connection Acknowledgement Packet that the connection path is set up to the destination network node, and then communicates in a connection-oriented manner via the port on which it received the Connection Acknowledgement Packet. In this way, the network is again able, in a self-organizing manner and without central instances, to set up an optimum connection path for directional messages.

In a further development of the invention, the source network node, after receiving the Connection Acknowledgement Packet, transmits a Connection Established Packet of the broadcast type. All network nodes which receive this packet before the Connection Acknowledgement Packet are not in the established connection path and delete their marking of the first routing port. All network nodes which are not involved are thus reset.

In a further development of the invention, a required QoS is specified for the data packets of the directional type.

In a further development of the invention, a special connection cleardown functionality is implemented, according to which a previously established connection path for directional data is again cleared down. This can be initiated by the source or destination network node, or an intermediate network node, in each case by transmitting a suitable connection end data packet of the directional type with the result that all network nodes along the connection path again delete their routing markings.

In a further design of the invention, including a functionality for signalling interruptions of an established connection is provided, including the transmission of a connection interruption data packet as a connection end packet by a relevant network node, if the latter establishes the loss of an adjacent node for which it has a marked routing port.

In a further configuration, the network is designed in such a way that the source network node, in response to the reception of a connection interruption packet, makes a further connection set-up attempt by generating and transmitting a new connection request packet.

### BRIEF DESCRIPTION OF THE DRAWINGS

Advantageous design forms of the invention are shown in the drawings and are described below, wherein:

FIG. 1 shows a schematic block diagram of network nodes of a decentralized, self-organizing data communications network to illustrate an adjacent monitoring functionality,

FIG. 2 to 10 show schematic block diagrams of network nodes of a decentralized, self-organizing data communications network to illustrate a broadcast functionality in consecutive operating cycles,

FIG. 11 to 29 show schematic block diagrams of the network nodes according to FIG. 1 to 10 to illustrate a connection set-up functionality in consecutive operating cycles,

FIG. 30 to 35 show schematic block diagrams of the network nodes according to FIG. 2 to 10 to illustrate a connection cleardown functionality in consecutive operating cycles,

FIG. 36 to 50 show schematic block diagrams of the network nodes according to FIG. 2 to 10 to illustrate a connection set-up in the event of a cell loss,

FIG. 51 to 63 show schematic block diagrams of network nodes of a decentralized, self-organizing data communications network to illustrate an island connection by an additional network node,

FIG. 64 to 70 show schematic block diagrams of an interconnection comprising three network nodes of a self-organizing, decentralized data communications network to illustrate an activation process,

FIG. 71 to 78 show schematic block diagrams of a network example to illustrate the removal of a network node with no resulting island formation,

FIG. 79 to 82 show schematic block diagrams of a network example to illustrate the removal of a network node with resulting island formation,

FIG. 83 to 87 show schematic block diagrams of a network example to illustrate an early connection cleardown, and

FIG. 88 to 99 show schematic block diagrams of a network example to illustrate a situation with broadcast messages overtaking one another.

### DETAILED DESCRIPTION OF THE INVENTION

The invention is explained below with reference to network examples, which relate to possible implementations of a distributed data communications network with self-organizing communications management, of the type which is suitable, for example, for modern motor vehicles, in which control devices, actuators, sensors and other electronic components are networked accordingly with one another. The various functionalities described below can in each case be provided individually or in any given combination in a relevant network implementation. At the highest configuration level, the data communications network according to the invention has all described functionalities. Due to the functionalities described in detail below, the network according to the invention satisfies the various aforementioned requirements, such as robustness, topology flexibility, expandability and scalability, use of identical components, universality, and real-time and ability.

All network nodes of the network according to the invention have a unique identifier, i.e., node ID, symbolized in the figures by simple numbering of the network nodes. The information is transmitted in the form of data packets that contain the packet type and the sender address as meta information, i.e., header information. The network nodes implement routing functionalities that make do with local information concerning their own condition and concerning direct adjacent nodes. The network nodes contain routers that can be implemented in a conventional manner, for example, as hardware, for example, using programmable logic devices (PLD) or field programmable gate arrays (FPGA). The node functions thereby remain unaffected as long as the network node is only a carrier, i.e., a gateway, and not a receiver, thereby enabling genuine parallelism.

In terms of communications types, in particular connectionless communications in the form of data packets of a non-directional type, i.e., a broadcast type and connection-oriented communications in the form of data packets of a directional type, i.e. a connection-oriented type, are implemented. In the case of the broadcast type, all nodes except the transmitter receive the message, whereby, however, the possibility of rejecting the message exists. A basic bandwidth is reserved on each line for the broadcast messages. Broadcast messages that cannot be forwarded immediately by a network node are stored locally. This ensures that all broadcast messages can be transferred at some time, regardless of the network load. Data packets of the broadcast type have no guaranteed transmission time.

For connection-oriented communications, a Quality of Service (QoS) in the form of a maximum transmission time and a reserved bandwidth is specified during the connection set-up. The algorithm according to the invention for the connection set-up establishes only communications paths of the type which satisfy the required QoS. In the case of the connection-oriented communications type, two network nodes are in each case logically connected as adjacent, direct communications parties. The logical connection is retained until it is cleared down by the transmitter, interrupted by the receiver or interrupted as a result of a fault. Changes to the network topology during operation are signalled as a broadcast message to all nodes in the network.

A packet type designated as a ping data packet, which comprises only header information with its own node ID as a sender address and the “ping” packet type information and is not forwarded by the relevant received network node, is provided as a special additional data packet type for the purpose of providing an adjacent monitoring functionality. Each network node activates the relevant port, if and as soon as it has received a ping data packet on the port, and internally maintains a table with the node IDs of the direct adjacent nodes recognized in this way. If a new adjacent node has been recognized, either because no adjacent node ID or a different adjacent node ID was previously contained in the node ID table for the port concerned, the node signals this recognized topology change by a Cell Found data packet of the broadcast type to all other nodes in the network.

The ping packet type is the only message type that is transmitted periodically. The cycle time between 2 ping data packets is the same on all network nodes. As soon as no ping data packet and no other message have been received on a port for a predefinable number of cycles, e.g., two cycles, the relevant network node evaluates this in such a way that an adjacent network node previously connected thereto is lost, e.g., due to removal of the node, due to a defect in said node, or due to a fault on the transmission path to this adjacent node. Following recognition of the loss of an adjacent node, the relevant network node sends a Cell Lost data packet of the broadcast type containing the node ID of the lost adjacent node as data content. If a network node that interconnects two subnetworks fails, the Cell Lost message is generated in both subnetworks, since the nodes adjacent to the failed node from both subnetworks notice the absence of the latter's ping data packets.

At hardware level, all network nodes except for any peripheral network nodes are equipped with identical communications capabilities and at least three communications ports, whereby the latter enables any given network topologies using only robust point-to-point connections. Depending on the situation, the network may contain additional peripheral network nodes that are simplified but compatible, in that they have, for example, only one port, a simplified protocol and no routing capability. Conventional types of data protocols can be used, insofar as they are suitable for providing the implemented functionalities, as will be made clear to the person skilled in the art by the present information. A data protocol based, for example, on the conventional TCP/IP protocol, which is modified according to the present special functionalities, is particularly suitable. The data protocol therefore presently requires no hierarchical structures and no domain name server.

FIG. 1 illustrates the ping mechanism in a simple example of a network with nine consecutively numbered network nodes. Here, and in all other Figures, each network node is represented by a hexagon, whereby each side of the hexagon represents a port, i.e., each network node has six ports. Network nodes adjacent to one another along one side of the hexagon represent direct adjacent nodes that are interconnected via their respectively associated port. Each node registers periodically by means of a ping data packet on all ports. FIG. 1 shows a time at which the network node 7 is transmitting a ping data packet of this type, whereby an arrow indicates here and in all other Figures that a data packet is being transmitted via the port concerned.

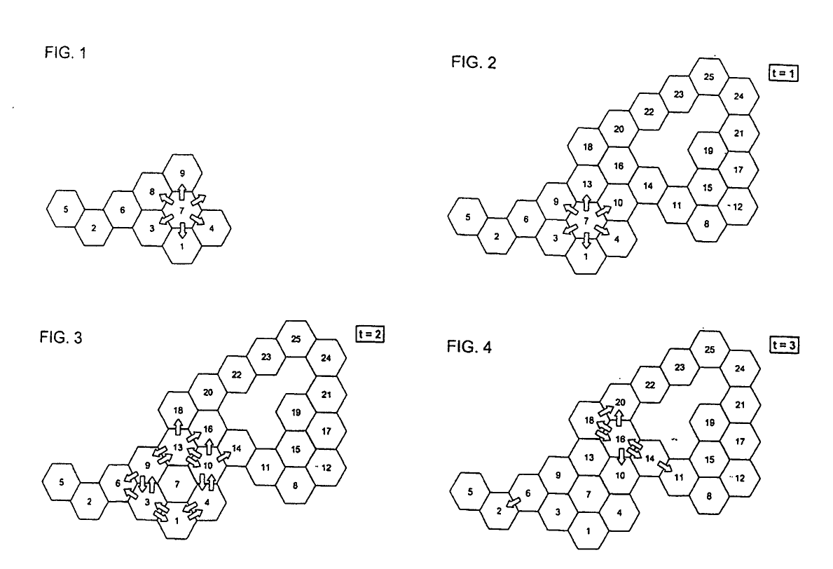

FIGS. 2 to 10 illustrate in consecutive clock cycles t=0,1,2, . . . the distribution of a broadcast data packet in a presented network example with twenty-five network nodes. In the first cycle shown in FIG. 2, the network node 7 transmits a broadcast packet corresponding to this packet type via all ports. Each network node that receives the broadcast data packet for the first time forwards it via all its other ports. This also applies in the event that the packet is received in the same cycle on a plurality of ports, such as, for example, in the second cycle shown in FIG. 3, those of the network node 6 or 16.

In order to minimize the network load due to broadcast transmissions, a cycle resolution is advantageously implemented in which a network node which has already received a broadcast packet rejects and does not forward said packet if it receives it again. To do this, each broadcast packet is provided with an identifying packet ID, and each network node keeps an internal list of the IDs of broadcast packets already received. A ring buffer with appropriate capacity, for example, is suitable for this purpose, so that the maximum number of all broadcast IDs to be registered which can occur within the maximum propagation time of a broadcast packet can be stored. The ring buffer can then be overwritten once more. This cycle resolution function minimizes the broadcast data traffic without losing broadcast messages. A unique broadcast packet ID can be generated without a central instance, for example, in that the generating network node attaches a node-internal counting value to its unique node ID.

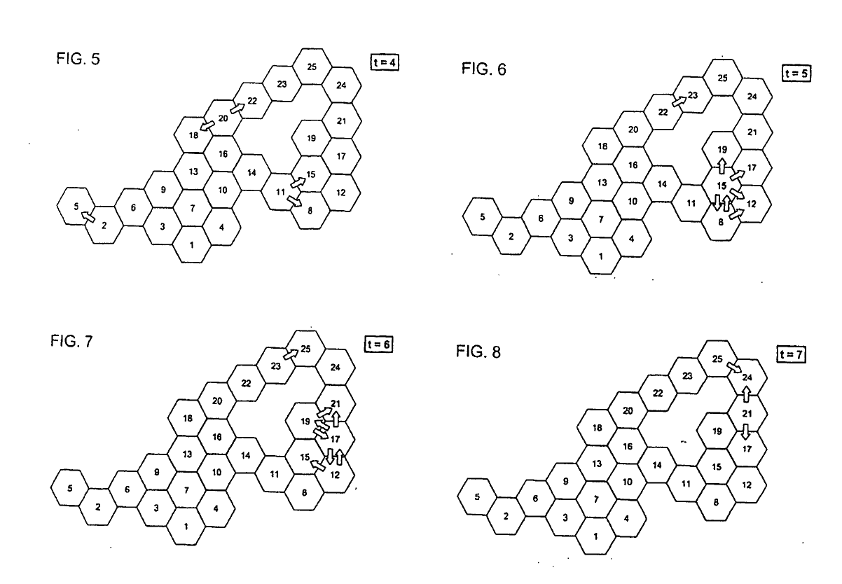

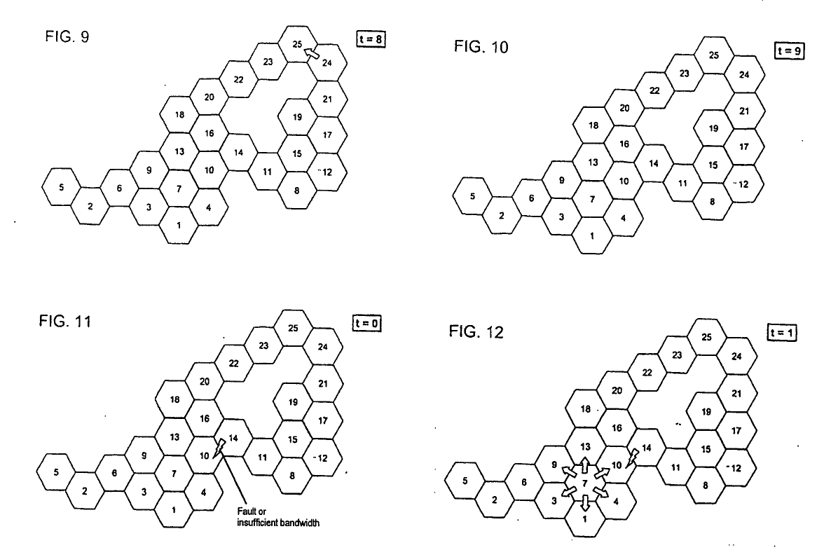

On the basis of these broadcast transmission characteristics, the further process of the broadcast data propagation according to FIGS. 3 to 10 is self-explanatory. Thus, for example, in the second cycle shown in FIG. 3, the nodes 1, 3, 4, 9, 10 and 13 adjacent to the initiating node 7 reject the broadcast packet received again in this cycle, as they have already received it in the first cycle shown in FIG. 2 from the network node 7. In the fifth cycle shown in FIG. 6, the two nodes 8 and 15 reject their reciprocally transmitted broadcast packets, as they have already received said packets in the previous cycle shown in FIG. 5 from the network node 11. Thus, the broadcast packet is propagated in the sequence shown in FIG. 2 to 9, as indicated by the transmission arrows, whereby, in the eighth cycle shown in FIG. 9, the final, still itinerant packet is transmitted from the node 24 to the node 25, but is rejected by the latter, as it had already received it previously in the sixth cycle shown in FIG. 7 from the node 23. In the condition shown in FIG. 10, all twenty-five network nodes have then received the broadcast packet from the node 7.

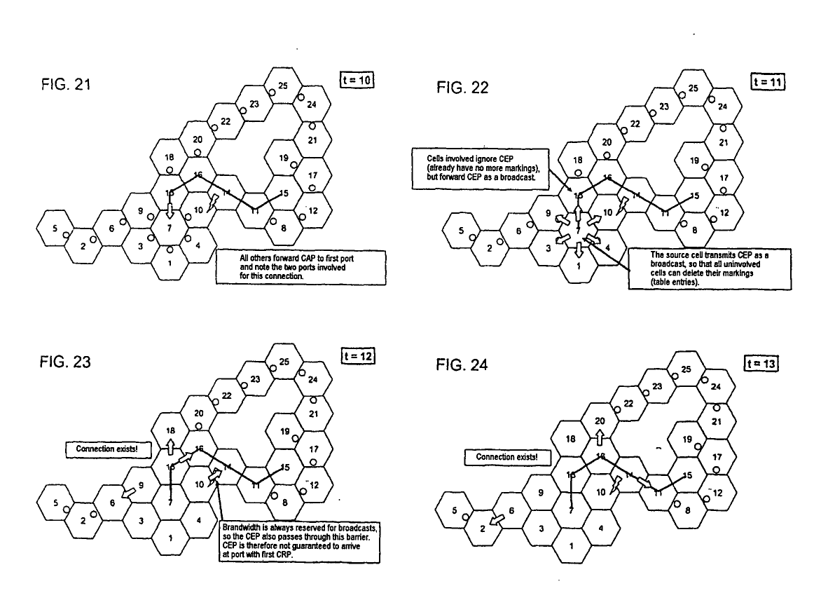

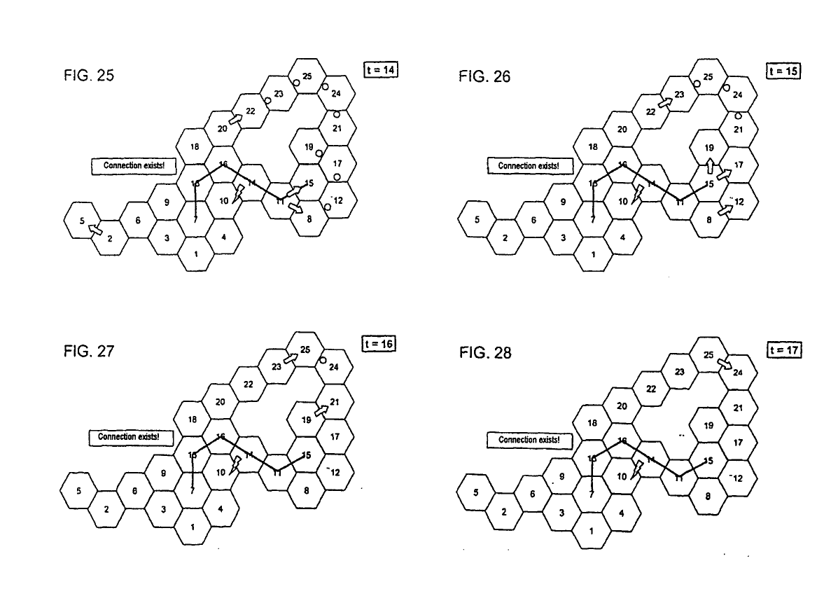

FIGS. 11 to 29 illustrate, in consecutive clock cycles, a connection set-up functionality implemented according to the invention, in order to set up a required connection between a transmitting source network node and a destination network node for the purpose of connection-oriented communications, i.e., transmission of data packets of the directional, connection-oriented type. The algorithm used for this purpose is based on a modification of the reverse path forwarding technique known per se, whereby the example shown in FIGS. 11 to 29 relates to the set-up of a one-way connection between the network node 7 as a message-generating node and the network node 15 as a message-receiving network node in the network topology shown in FIG. 2 to 10. Furthermore, FIGS. 11 to 29 illustrate a case in which the direct connection between the network nodes 10 and 14 for directional data packets cannot be used due to a fault or insufficient bandwidth, as indicated in FIG. 11. The message-generating node 7 starts the connection set-up by transmitting a Connection Request Packet (CRP) as a broadcast data packet on all ports, cf. FIG. 12. Thus, this CRP passes as a broadcast message through the network in the manner described above in relation to FIGS. 2 to 10.

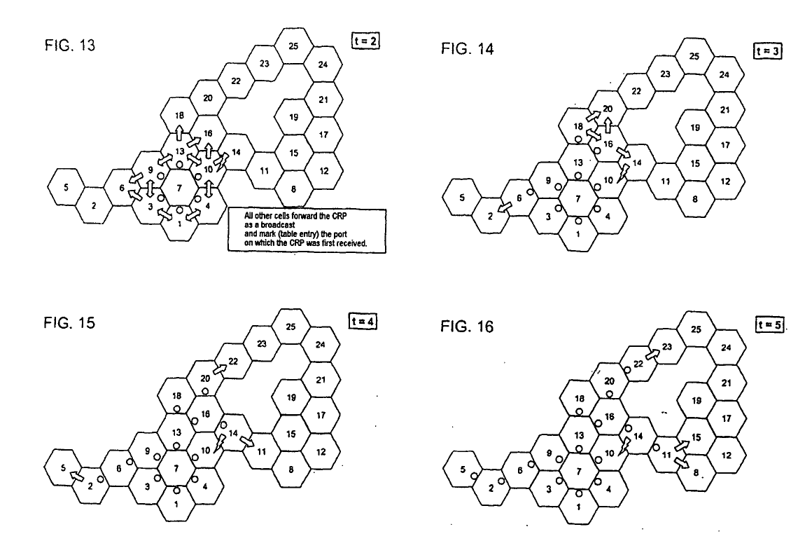

The CRP has the additional characteristic that each received network node marks the port on which it first receives the CRP with a first routing table entry, indicated in FIG. 13 to 27 in each case by a round circle. This decision is also made in a time-resolved manner for the case of a multiple reception in the same cycle, such as, for example, in the cells 6 and 16 in the second cycle according to FIG. 13. The CRP forwarded in the second cycle shown in FIG. 13 from the node 10 onto the port which is defective for directional connections to the node 14 is ignored by the node 14.

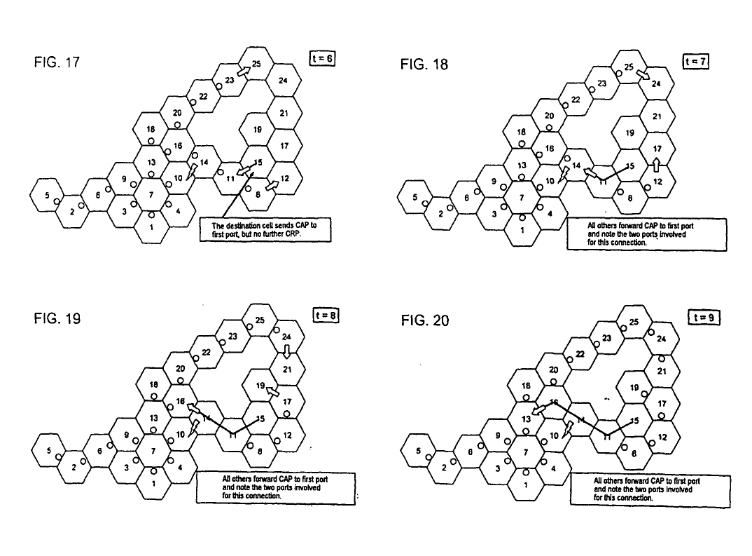

In the fifth cycle shown in FIG. 16, the destination node 15 receives the CRP for the first time. It forwards it no further. As illustrated in FIG. 17, it then generates and transmits back a Connection Acknowledgement Packet (CAP) in the next cycle on the port marked with the first routing entry. Each intermediate network node that receives the CAP marks the port on which it receives the CAP with a second routing table entry and forwards the CAP via its port with the first routing entry. In this way, the CAP passes to the source network node 7, as illustrated by a thick connection line in FIG. 17 to 22.

By receiving the CAP, the source network node 7 recognizes that the required connection to the destination network node 15 exists, i.e., an optimum connection path has been set up for directional messages, as represented in FIG. 23 by the thick connection line. The optimum connection path is defined completely and locally, i.e., with no central instance, by the transmitting port of the source network node 7, by the first and second routing entry for the two involved ports of each intermediate network node, and by the receiving port of the destination network node 15.

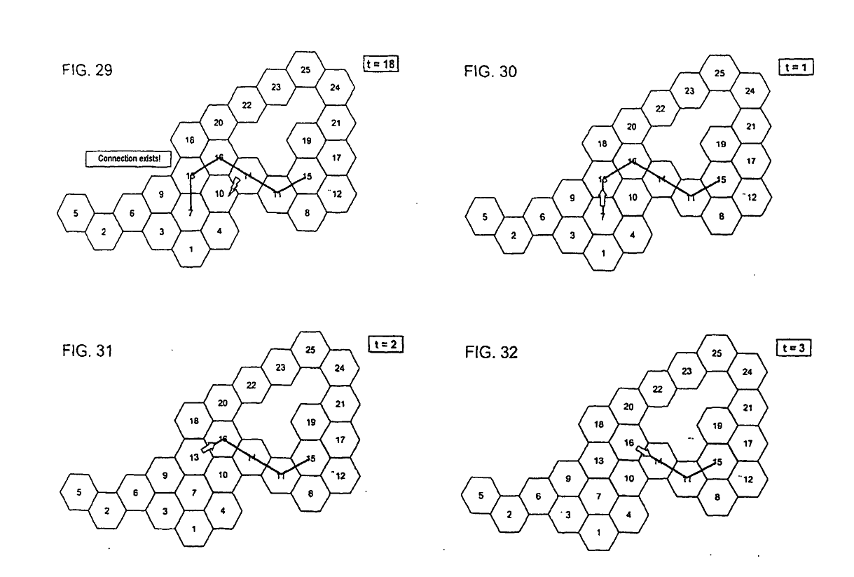

After receiving the CAP, the source network node 7 generates and transmits a Connection Established Packet (CEP) of the broadcast type. This serves the purpose that all network nodes not involved in the optimum connection path can once more delete their first routing entries. In other words, each network node that receives the CEP before receiving the CAP once more deletes its first routing marking. This is illustrated in the cycle sequence shown in FIG. 22 to 28. Finally, the uninvolved node 24 deletes its first routing entry in the 17th cycle shown in FIG. 28, whereupon, in the condition shown in FIG. 29, all nodes not involved in the optimum connection path are once more reset. The node 7 communicates by means of data packets of the directional type with the node 15 via the optimum connection path that has been set up.

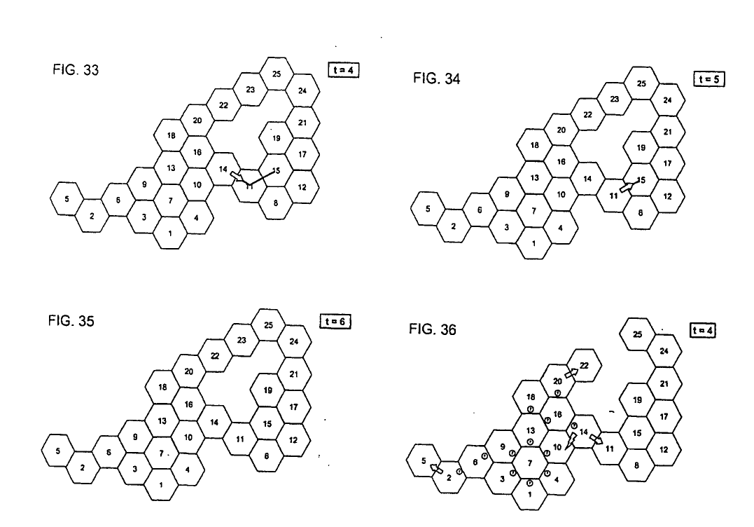

A connection established for directional messages may be cleared down once more, at the instigation of the source or destination network node. FIGS. 30 to 35 show an example of the connection set-up initiated by the source network node 7. To do this, the source network node 7 sends a Connection Terminate Packet (CTP) along the established connection. The CTP has the effect that each receiving node forwards the CTP on the established path and clears down the connection locally, i.e., deletes its two routing entries and once more releases the reserved resources. In this way, the connection is again completely cleared down following reception of the CTP by the destination network node 15 in the clock cycle shown in FIG. 34, and the network is then in the initial condition shown in FIG. 35. Alternatively to the example shown, the connection set-up can be initiated by the destination network node 15 in that the latter sends a Connection Broken Packet (CBP) via the established connection to the source network node 7, which has the same effect in each receiving network node as the CTP.

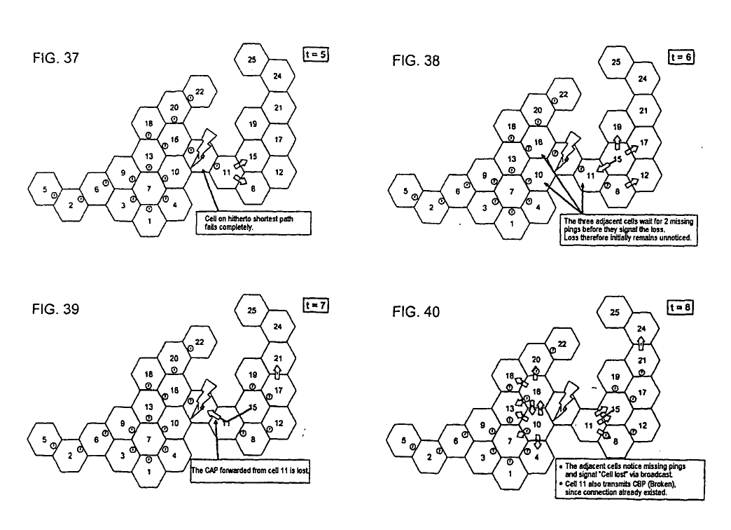

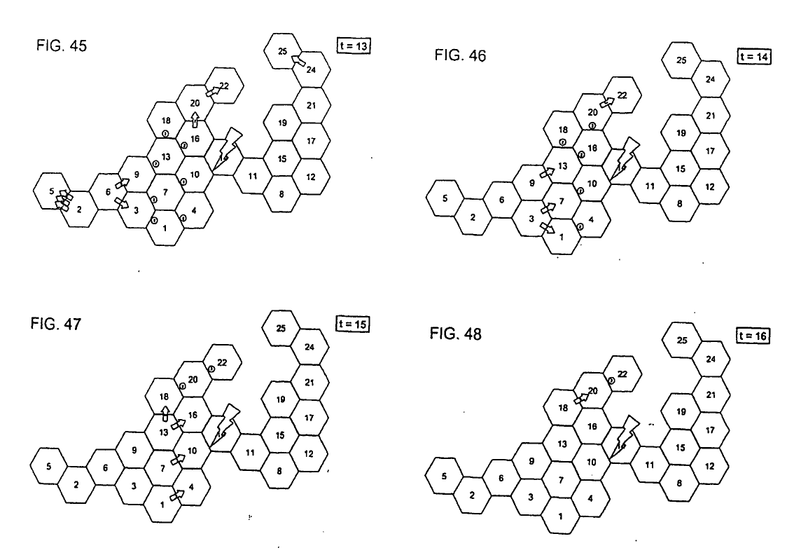

The example shown in FIG. 30 to 35 indicates that the procedure according to the invention enables an optimum connection to be set up and cleared down once more for directional messages purely through local measures without the involvement of a central instance. Faults can also be handled in an appropriate manner. FIGS. 36 to 50 illustrate a situation in which a node fails during the connection set-up, whereby the network topology is assumed to be similar to that of the above connection set-up example. Here it is assumed that the node 14 intrinsically lying on the optimum path fails completely after forwarding the CAP of the source network node 7, cf. FIG. 37. As a further modification, it is assumed that the node 23 not involved in the communication path between the nodes 7 and 15 is absent. Up to the fourth clock cycle, the connection set-up corresponds to the previously explained example, i.e., FIG. 36 corresponds apart from the absent node 23 to the situation shown in FIG. 15, whereby the number of the initiating node is additionally indicated in the symbolic circles and arrows.

The adjacent nodes 10, 11, and 16 wait, as explained above, two ping clock cycles until, due to the absence of corresponding ping data packets, they establish that the node 14 has failed, cf. FIG. 38. The CAP forwarded from the node 11 to the node 14 is lost there, cf FIG. 39. In the clock cycle shown in FIG. 40, the adjacent nodes 10, 11 and 16 start to dispatch a corresponding Cell Lost packet of the broadcast type, as explained above. The node 11 additionally transmits a Connection Broken Packet (CBP), since the connection already existed locally to it, after it has identified the fault. The Cell Lost Broadcast Packet (CLB) has the effect that the receiving node in each case deletes all routing markings. The CBP has the effect that the receiving node deletes the routing marking associated with the connection concerned.

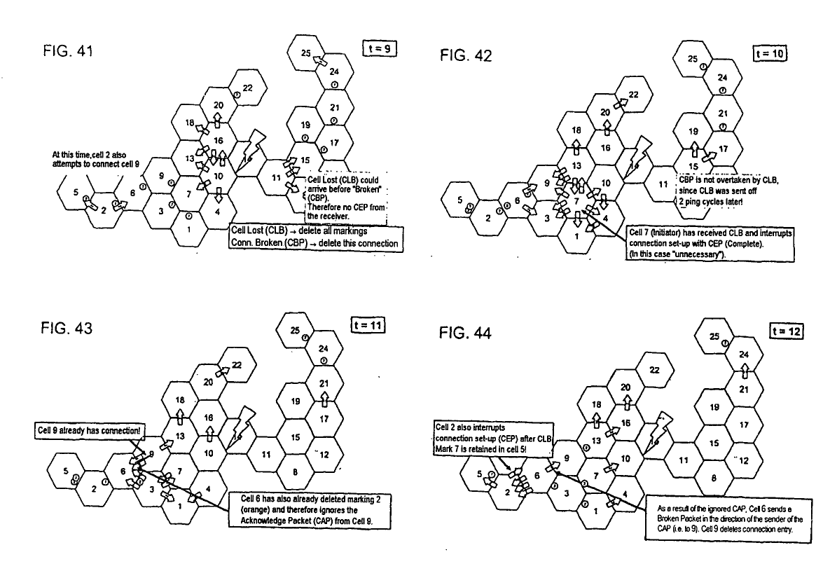

In the chosen network topology example, the result of the failure of the node 14 is that two islands are formed, one with the destination network node 15 and one with the source network node 7. In the island with the destination network node 15, the routing entries are then successively deleted, as revealed by the sequence shown in FIG. 40 to 46. In the other island, it is additionally assumed according to FIG. 41 that the network node 2 initiates a connection request to the node 9 in the relevant clock cycle and emits a corresponding CRP. As soon as the source network node 7 has received the CLB for the first time from the node 10, as shown in FIG. 42, it interrupts the connection set-up request, whereby it emits a CEP as a broadcast message which causes receiving network nodes to delete corresponding routing markings. In the example shown, the CEP is redundant, since the markings are already deleted due to the CLB.

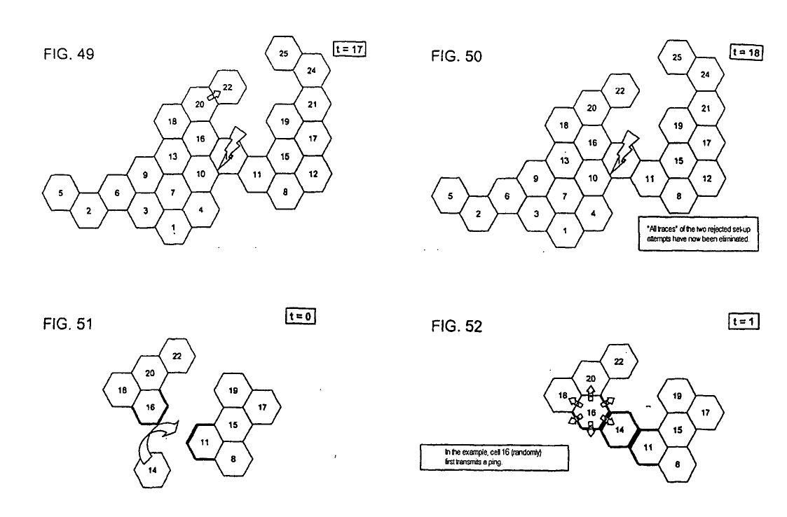

In the clock cycle shown in FIG. 42, the node 9 as the destination node furthermore receives the connection request from the source network node 2 and transmits back the corresponding CAP in the clock cycle shown in FIG. 43. In the meantime, however, the intermediate network node 6 has already deleted its first routing entry because it has received the CLB of the node 10 or the CEP of the node 7, and consequently ignores the CAP transmitted by the node 9. The node 6 therefore transmits a CBP back to the node 9, which then deletes its routing entry. After receiving the CLB, the source network node 2 also interrupts its connection request and transmits a corresponding CBP, which passes through all nodes of the associated island as a broadcast packet in the further clock cycles, with the result that all routing entries are finally deleted once more, finally, as shown in FIG. 49, in the node 22. With the new island topology, the network reverts once more to an initial condition as shown in FIG. 50, in which all traces of the two rejected set-up attempts have been eliminated, so that no pending requests remain.

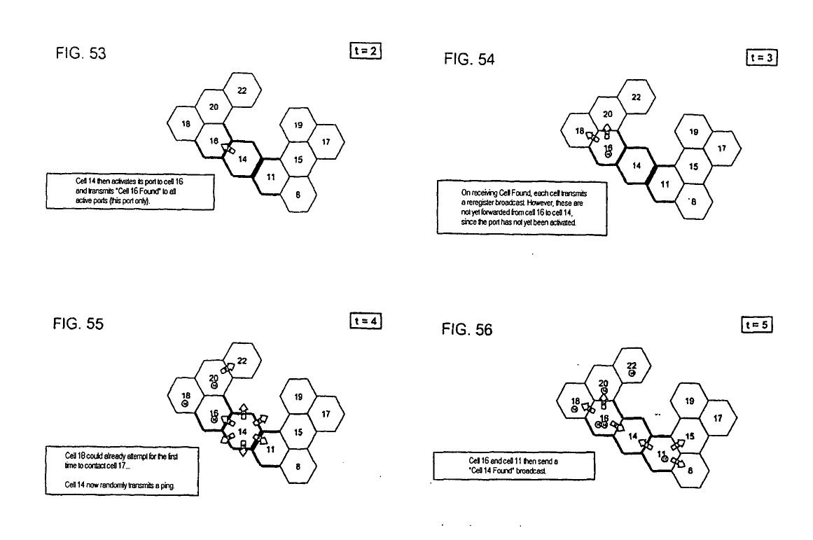

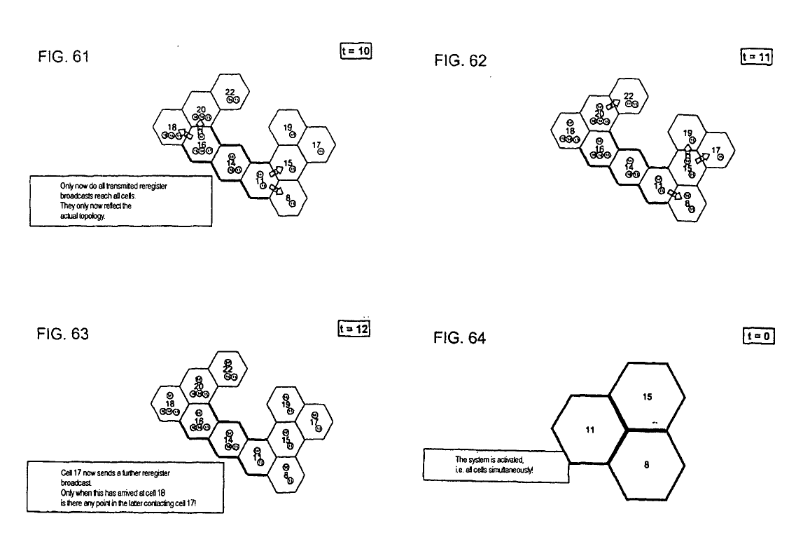

Conversely, FIGS. 51 to 63 show a case in which two network islands are interconnected by an additional network node 14, whereby the network reconfigures itself once more in its communications characteristics in a self-organizing manner purely through local measures. To do this, a reregister concept is used in which all network nodes reregister once more after a new network node has been recognized by its new adjacent node and has been made known in the network.

Following the addition of the node 14, as shown in FIG. 51, the additional node 14 is initially recognized, whereby, for example, according to FIG. 52, the adjacent node 16 randomly transmits a ping data packet. The node 14 then activates its port to the node 16 and, since only this port is currently active, transmits a Cell Found broadcast packet relating to the detection of the adjacent node 16 on this port. The Cell Found message from the node 14 is therefore forwarded successively only to the other nodes connected to the node 16, in this case the nodes 18, 20, and 22. According to the reregister concept, each node transmits a reregister broadcast packet on receiving a Cell Found message. However, the packet is not yet forwarded from the node 16 to the node 14, since the relevant port of the node 16 has not yet been activated. In the cycle shown in FIG. 55, the node 14 sends a ping data packet for the first time. The adjacent nodes 11 and 16 in each case then activate their associated port and transmit a Cell Found broadcast packet relating to the detection of the new adjacent node 14. However, since the node 14 has not yet received a ping data packet from the adjacent node 11, it has not yet activated its associated port and forwards no packets to the node 11.

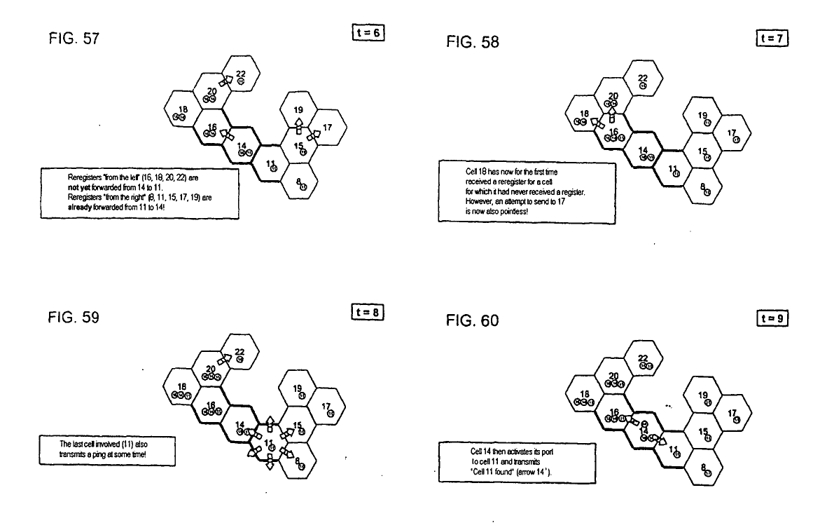

By way of illustration, in FIGS. 55 to 63, the hexagon sides in the case of which the two associated ports have not yet been activated and which therefore do not yet represent a two-way connection are represented by thick lines. Reregister broadcast packets are already forwarded accordingly in the network condition shown in FIG. 57 from the node 11 and the connected nodes 8, 15, 17 and 19 to the node 14, but still no reregister broadcast packets are forwarded from the node 14 and the connected nodes 16, 18, 20 and 22 to the node 11 and the nodes 8, 15, 17 and 19 connected to the latter. In this way, for example in the condition shown in FIG. 58, the node 18 has received a reregister message for the first time from the node 11, but cannot yet transmit it, for example, to the node 17.

FIG. 59 then shows the time at which the last network node 11 affected by the installation of the new node 14 also transmits a ping data packet. As a result, the node 14 activates its associated port and transmits the Cell Found broadcast packet relating to the detection of the new adjacent node 11, indicated in FIG. 60 to 63 by the number 14′ in the circular reregister message symbol. Only then do all transmitted reregister messages reach all network nodes and, as soon as the last reregister broadcast message has also reached all nodes, the new network topology is known locally in all nodes, so that any given communications processes can be carried out.

In the worst case, i.e., in the case of the longest-lasting island connection, a node is inserted in such a way that it is connected on each port to its own island, whereby double the number of Cell Found broadcast packets arises and each node replies with exactly the same number of reregister broadcast packets. In the short term, there is no guarantee that a node can be contacted only because one reregister packet has been received from it. However, when the second reregister message of a node is received, this node can definitely be contacted.

A further situation is represented by the activation of a network node interconnection. Without special handling, all nodes would register via a ping data packet with all other adjacent nodes and each of these nodes would generate a Cell Found broadcast packet, to which all nodes would in turn reply with a reregister packet. These messages would be transmitted almost simultaneously, and would therefore result in a high network load, even in the event of parallel transmission. A special activation handling is provided as a remedy. This first ensures that all ports are activated by waiting an adequate number of ping cycles. Only then do the nodes transmit their Cell Found broadcast messages. In this way, the maximum number of messages of this type increases with the number of network nodes in only a linear, rather than a quadratic, manner.

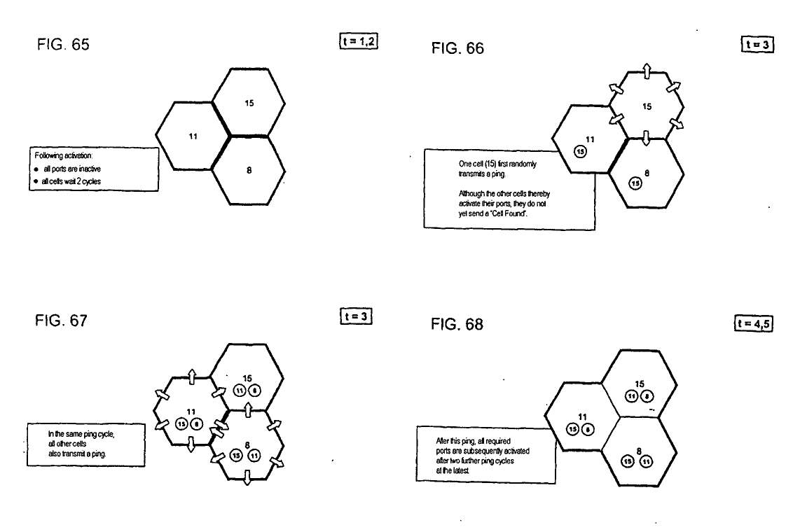

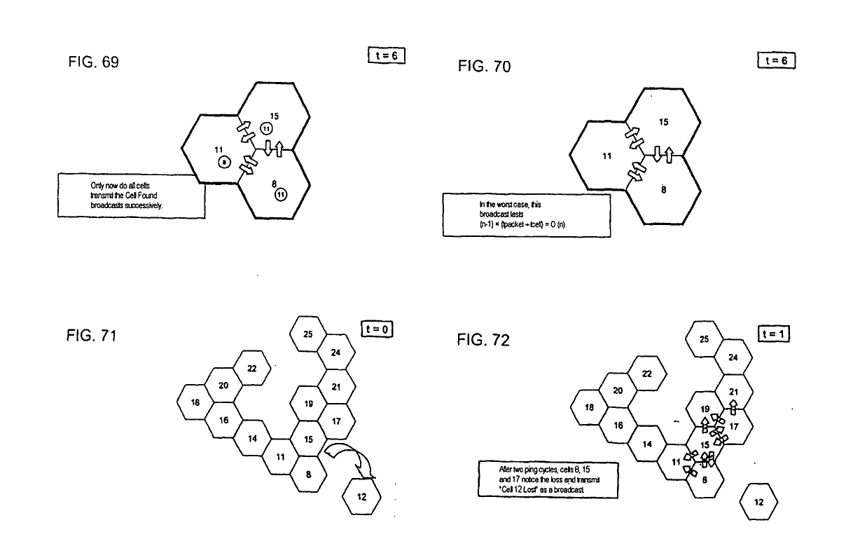

FIGS. 64 to 70 illustrate this by way of a simple example of three network nodes 8, 11, and 15, whereby connections not yet bidirectionally activated are again represented by thick lines. Following the activation of the cell interconnection shown in FIG. 64, all ports are initially inactive, as shown in FIG. 65, and all nodes wait two clock cycles. Then, for example, the node 15, as shown in FIG. 66, first transmits a ping data packet, whereby the adjacent cells 8 and 11 activate their respective associated port, but do not yet send a Cell Found packet. In the same ping cycle, the nodes 8 and 11 in each case also transmit a ping data packet, cf. FIG. 67, so that, after two further clock cycles at the latest, all required ports are activated, cf FIG. 68. Only now do all nodes successively transmit the Cell Found broadcast packets, cf. FIG. 69, and after one time period at the latest, which increases in a linear manner with the number n of network nodes, all Cell Found broadcast messages have been received, cf. FIG. 70. Reregister messages are therefore permitted only after this time period which is dependent in a linear manner on the number n of network nodes, so that a correct reregister process is guaranteed, even in the case where two islands are connected.

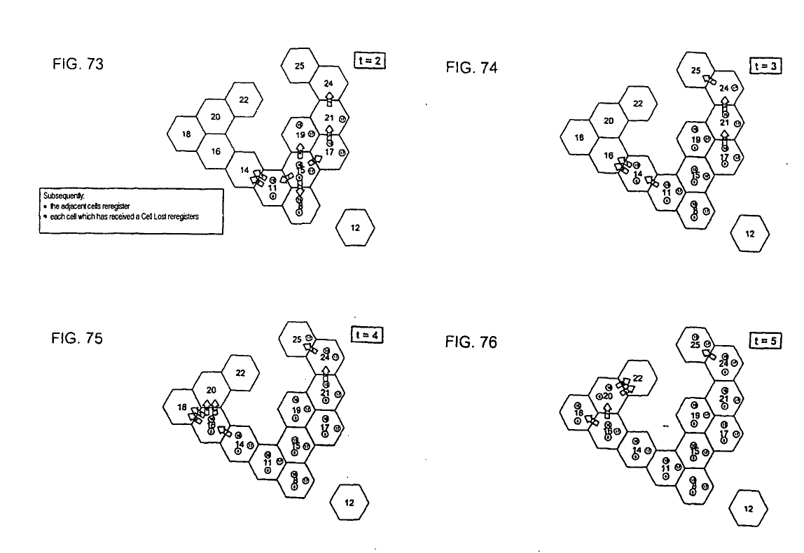

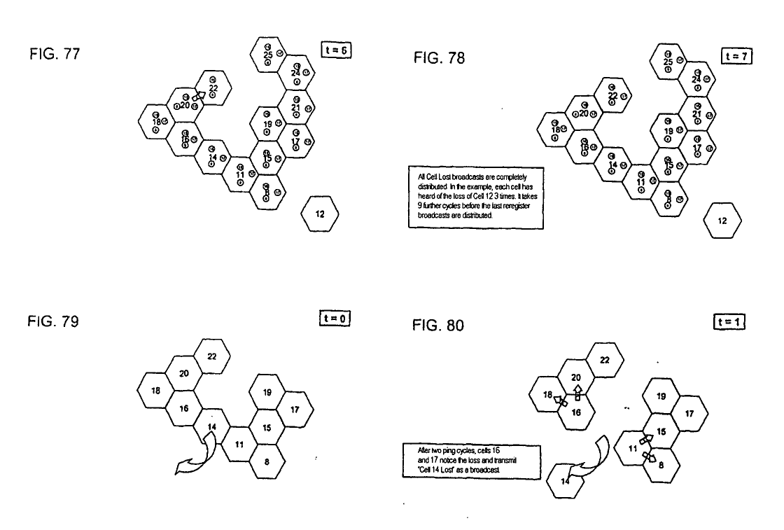

FIGS. 71 to 78 illustrate the handling of a case in which a node 12 in a network topology shown therein is removed with no resulting island formation. After two ping cycles, on the basis of the initial condition shown in FIG. 71, the nodes 8, 15 and 17 notice the loss of the adjacent node 12 and transmit a corresponding Cell Lost packet as a broadcast message, cf FIG. 72. The reception of the Cell Lost data packet initiates a reregister broadcast message for reregistration in each receiving node, again represented in each case in FIG. 73 to 78 by a numbered circle. The Cell Lost and reregister packets are then propagated in the manner shown via the network node interconnection, cf. FIG. 73 to 77. In the final condition shown in FIG. 78, all Cell Lost broadcast messages are distributed, and, in this example, each node has suffered the loss of the node 12 three times. It then takes a further nine clock cycles before the last reregister broadcast messages are distributed. In the longest-lasting case, a node failure therefore gives rise to a number of broadcast messages which increases with the product of the number of ports per node and the number of nodes in the network.

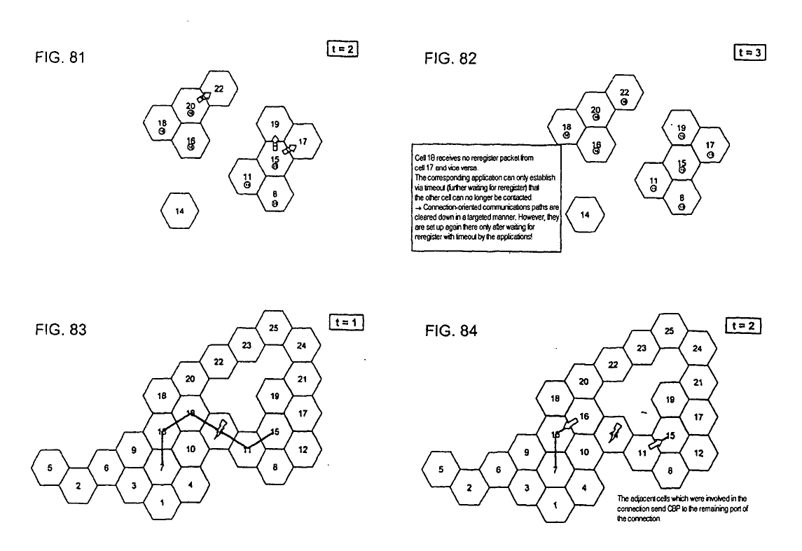

FIGS. 79 to 82 illustrate a situation in which a node 14 is removed with resulting island formation, in contrast to the island connection case shown in FIGS. 51 to 63. Following the removal of the node 14 according to FIG. 79, the adjacent nodes 11 and 16 notice the loss of the adjacent node 14 after two ping cycles and transmit a corresponding Cell Lost broadcast message, which passes via the relevant island, cf FIG. 80 to 82. Following the reception of the Cell Lost message, the relevant node again transmits a reregister broadcast message. However, due to the island formation, no further reregister messages are received from the nodes of the respective other island. Via a suitably selected timeout application, it is then established that no further reregister message is received from the nodes of the other island. Connection-oriented communications paths, if present, are cleared down in a targeted manner. They are only re-established following a timeout waiting for reregister messages.

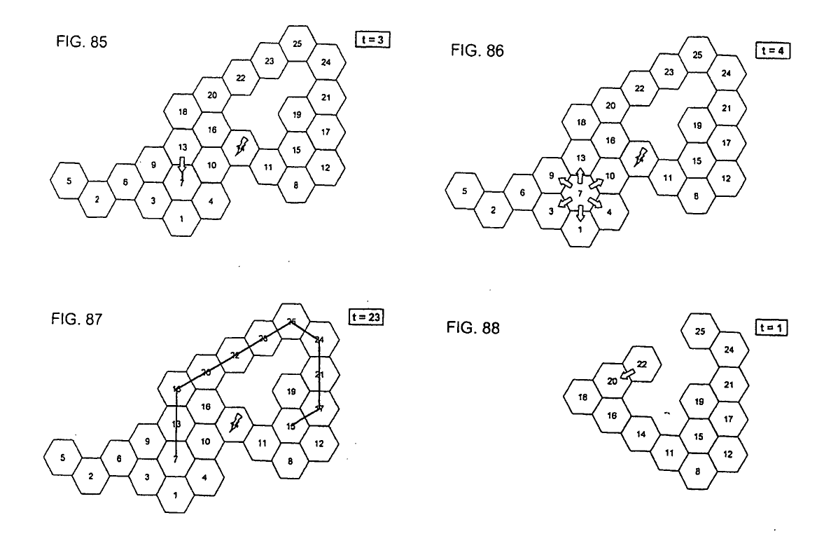

FIGS. 83 to 87 illustrate a situation in which an established connection between a source network node 7 and a destination network node 15 in the network, with reference to which the examples of the set-up and cleardown of a connection for directional messages were explained according to FIGS. 11 to 35. FIG. 83 shows the time at which the connection exists and an involved intermediate network node 14 fails. The nodes 11 and 16 adjacent to the failed node 14 and involved in the connection in each case send a CBP along the connection path to the source network node 7 or destination network node 15, whereby the connection path is successively deleted, cf. FIGS. 84 and 85.

As an optional functionality, it is provided that the source network node 7 attempts a new connection set-up after receiving the CBP, and in turn transmits a corresponding Connection Request Packet as a broadcast message for this purpose, cf. FIG. 86. The further connection set-up process then takes place as described above, until a new optimum connection path is finally set up from the source network node 7 to the destination network node 15, as shown in FIG. 87.

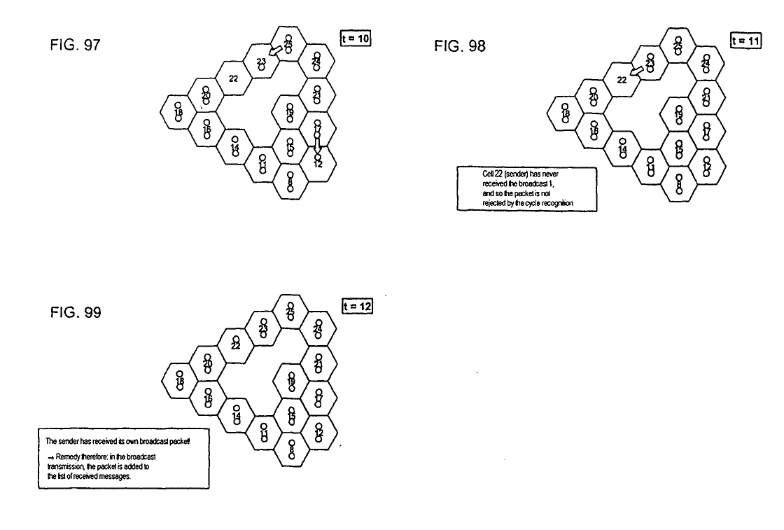

FIGS. 88 to 99 illustrate a case in which broadcast messages overtake one another. If the network topology changes while broadcast messages are in transit, their reception sequence cannot be guaranteed, since the new topology may provide shorter paths that can be used immediately by a broadcast message.

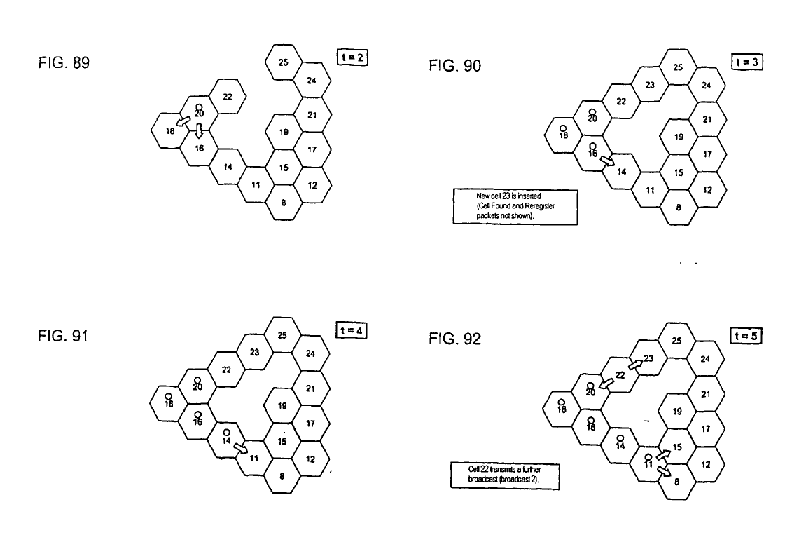

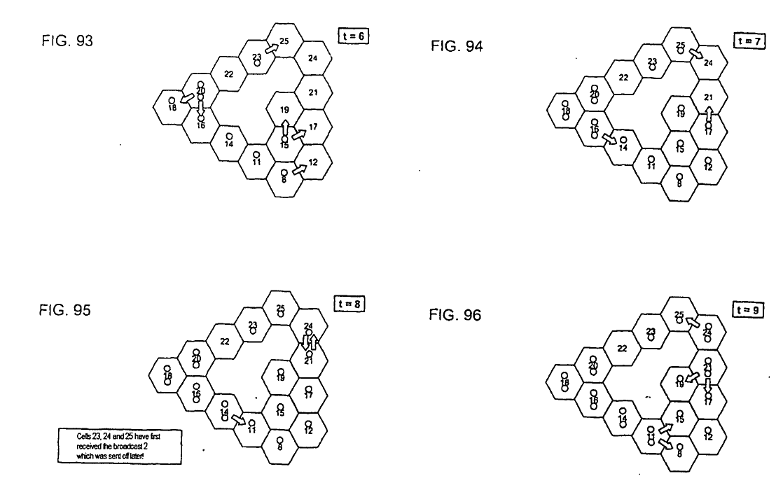

In the initial condition shown in FIG. 88, a node 22 transmits a broadcast message, whereby the reception shown in FIGS. 89 to 99 is in each case marked by a circular symbol. In the clock cycle shown in FIG. 90, a new node 23 is inserted into the network. Two clock cycles later, as shown in FIG. 92, the node 22 transmits a second broadcast message which then also passes via the newly inserted adjacent node 23. As a result, the node 23 and the adjacent nodes 25 and 24 receive the second broadcast message from the node 22 before the first broadcast message, cf. FIGS. 93 to 95. In the clock cycle shown in FIG. 98, the node 22 receives its own first broadcast message. Since it had not received it previously, it would forward it unnecessarily in accordance with the other broadcast transmission rules. To prevent this, it is provided in the source network node that the broadcast packet ID is added to the list of received broadcast packets when the broadcast packet is generated, so that the node 22, in the cycle shown in FIG. 98, forwards its received broadcast message no further. In the final condition shown in FIG. 99, all nodes have then received both broadcast messages, albeit not all at the correct time.

The example embodiments shown and explained above clearly indicate that the invention provides a distributed data communications network with self-organizing communications management that requires no central instances and is also suitable for safety-critical applications with real-time requirements, e.g., for the implementation of data communications networks in motor vehicles. The various functionalities described, such as the special adjacent monitoring and broadcast transfer, and also the special connection set-up and reregister concept, can be implemented individually or in any given combination depending on the network design, eliminating the need for central instances, such as those with higher intelligence or communications capability than other network nodes. Moreover, network nodes with identical communications capability can be used throughout to set up the network, apart from any simpler peripheral network nodes.

The hardware and software units required to carry out the functionalities described are implemented in the network nodes in a manner immediately obvious to the person skilled in the art with knowledge of these required functionalities. This includes, in particular, a suitable data packet router, which, inter alia, manages the connection-oriented communications by means of a routing table. Due to the decentralized organization of the connection set-up, the router of a network node always knows the optimum outgoing port for an incoming directional data packet, and the overall connection path is determined from the routing entries in the individual network nodes.

In an advantageous design form, the network nodes are set up in an identical manner with more than 2 ports, whereby a subset of the communications ports can be dynamically activated and de-activated during the runtime of the data communications network.

1-11. (canceled)

12. A data communications network comprising:
a plurality of electronic components; and
at least one control device,
wherein said electronic components and said at least one control device being networked via data bus lines,
said at least one control device further comprising:
a plurality of network nodes, each of said nodes having one or more communications ports and an identifying node ID and being designed to manage connections decentrally and to transmit data packets of a non-directional type and/or a directional type, wherein said data packets contain at least header information concerning at least a packet type and a node ID of a packet-generating network node.

13. The network of claim 12, wherein each of said plurality of network nodes is configured to
monitor functionality of one or more adjacent network nodes,
periodically transmit a ping data packet with header information that is not to be forwarded,
activate one or more communication ports on which it has received a ping data packet from one of said one or more adjacent network nodes within a predefinable registration time,
maintain an associated list of directly connected adjacent network nodes,
update said adjacent network node list and transmit an associated Cell Found data packet of said non-directional type if said network node recognizes a new adjacent node on a port on the basis of an associated received ping data packet, and
evaluate a loss of a previous adjacent node, update said adjacent network node list, and transmit an associated Cell Lost data packet of non-directional type if said adjacent network node receives no further ping data packet and no other data packets on a hitherto activated port within the registration time.

14. A device for controlling electronic components networked with one another via data bus lines in a data communications network comprising:
a plurality of network nodes, each of said nodes having one or more communications ports and an identifying node ID and being designed to manage connections decentrally and to transmit data packets of a non-directional type and/or a directional type, wherein said data packets contain at least header information concerning at least a packet type and a node ID of a packet-generating network node, each of said network nodes further comprising:
means for monitoring functionality of one or more adjacent network nodes;
means for periodically transmitting a ping data packet with header information that is not to be forwarded;
means for activating one or more communication ports on which it has received a ping data packet from one of said one or more adjacent network nodes within a predefinable registration time;
means for maintaining an associated list of directly connected adjacent network nodes;
means for updating said adjacent network node list and for transmitting an associated Cell Found data packet of said non-directional type if said network node recognizes a new adjacent node on a port on the basis of an associated received ping data packet, and
means for evaluating a loss of a previous adjacent node, updating said adjacent network node list, and transmitting an associated Cell Lost data packet of non-directional type if said adjacent node receives no further ping data packet and no other data packets on a hitherto activated port within the registration time.

15. A method for controlling electronic components via one of a plurality of networked nodes, wherein said components networked with one another via data bus lines in a data communications network, comprising:
monitoring functionality of one or more adjacent network nodes;
periodically transmitting a ping data packet with header information that is not to be forwarded;
activating one or more communication ports on which said one of a plurality of networked nodes has received a ping data packet from one of said one or more adjacent network nodes within a predefinable registration time;
maintaining an associated list of directly connected adjacent network nodes;
updating said adjacent network node list and transmitting an associated Cell Found data packet of said non-directional type if said one of said plurality of network nodes recognizes a new adjacent node on a port on the basis of an associated received ping data packet; and
evaluating a loss of a previous adjacent node, updating said adjacent network node list, and transmitting an associated Cell Lost data packet of non-directional type if said adjacent node receives no further ping data packet and no other data packets on a hitherto activated port within the registration time.

16. The method of claim 15, further comprising selecting a predefinable number of cycles of said periodically transmitted ping data packets as the registration time.

17. The method of claim 15, further comprising transmitting a reregister data packet of the non-directional type in response to the reception of a Cell Found data packet or Cell Lost data packet.

18. The method of claim 13, further comprising:
providing said data packets of non-directional type with an identifying packet ID;
maintaining a list of the packet IDs of already received data packets of the non-directional type and, with reference to said list, checking whether an instantaneously received data packet of non-directional type has already been received;
rejecting said instantaneously received data packet of the non-directional type if the network node establishes that the instantaneously received data packet of the non-directional type has already been received;
forwarding said instantaneously received data packet of the non-directional type to all directly connected adjacent nodes if the network note establishes that the instantaneously received data packet of the non-directional type has not already been received.

19. The method of claim 18, wherein said packet ID is formed by linking a node ID characterizing a network node with a unique ID generated locally in the network node.

20. The method of claim 15, further comprising:
transmitting a Connection Request Packet (CRP), which is transmitted as a data packet of the non-directional type and which contains information concerning a destination network node;
storing a port ID of a port on which said one of a plurality of networked nodes first received the CRP as a first routing port of routing information;
transmitting from said destination network node a Connection Acknowledgement Packet (CAP) after receiving the CRP only on the port on which it first received the CRP;
forwarding from one or more intermediate network nodes the CAP on stored first routing ports and storing the port ID of the receiving port as the second routing port in the routing information;
recognizing by a source network node the reception of the CAP; and
communicating with said destination network node through data packets of the directional type via the port that receives the CAP.

21. The method of claim 20, further comprising:
transmitting from said source network node a Connection Established Packet (CEP) of the non-directional type in response to the reception of the CAP; and
deleting marking of said first routing port by all network nodes receiving receive the CAP before the CAP.

22. The method of claim 20, further comprising defining a Quality of Service for said data packets of the directional type by specifying a required bandwidth and maximum transmission time.

23. The method of claim 20, further comprising:
implementing a connection cleardown functionality to clear down an established connection for transmission of data packets of the directional type, according to which a connection end packet of the directional type is transmitted from said source network node to said destination network node or from the destination network node to the source network node or from an intermediate network node to the source or to the destination network node, on reception of which the intermediate network node(s) involved in the connection once more delete their routing port information.

24. The method of claim 23, further comprising:
implementing a connection interruption functionality according to which an intermediate node involved in an established connection transmits a connection interruption packet of the directional type as a connection end packet to the remaining connection adjacent nodes, if it recognizes the loss of the other connection adjacent node.

25. The method of claim 24, further comprising transmitting by said source network node a new connection set-up request by transmitting a new CRP in response to the reception of a connection interruption packet.
